(19) United States
(12) Patent Application Publication
(10) Pub. No.: US 2017/0046634 A1
(43) Pub. Date: Feb. 16, 2017

(54) PROVIDING ON-DEMAND GEOLOCATION BEAUTY SERVICES AND BEAUTY INDUSTRY SOCIAL NETWORKING SERVICES THROUGH USE OF PORTABLE COMPUTING DEVICES

(71) Applicants: Alexander Terzian, Boston, MA (US); William Nixon, JR., South Easton, MA (US); Jared Reid, Reading, MA (US)

(72) Inventors: Alexander Terzian, Boston, MA (US); William Nixon, JR., South Easton, MA (US); Jared Reid, Reading, MA (US)

(21) Appl. No.: 15/233,908

(22) Filed: Aug. 10, 2016

Related U.S. Application Data
(60) Provisional application No. 62/203,418, filed on Aug. 11, 2015.

(51) Int. Cl. G06Q 10/02; G06Q 50/00; G06F 17/30

(52) U.S. Cl. CPC G06Q 10/02; G06F 17/3089; G06Q 50/01

(57) ABSTRACT

A system and method for real-time viewing, ordering, and scheduling of on-demand beauty services that connect consumers to beauty service providers through use of portable computing devices.

### CROSS REFERENCE TO RELATED APPLICATION

This application claims the benefit of U.S. Provisional Patent Application No.: 62/203,418, filed on Aug. 11, 2015, the contents of which are incorporated herein by reference.

### FIELD OF THE INVENTION

This invention relates to a beauty industry social media software platform designed to provide on-demand geolocation beauty services that connect consumers to stylist through use of portable computing devices.

### BACKGROUND OF INVENTION

People look to hair salons and hairstylists to help them achieve their best looks in order to feel confident. Obtaining these best looks often requires the client to try multiple hairstylists, and to develop long term relationships with the stylist they prefer. It can be a long and tedious process for a client to trust a hairstylist since it takes time and repeated stylings for a hairstylist to remember a client's preferences, or to develop a style for the client. This process may need to be repeated once the client seeks out a new look.

Furthermore, it can be difficult for a client to articulate or maintain a new hairstyle using only words. A client may ask a stylist to recreate a hair style from a magazine or other type media. The hairstylist not have experience with recreating such hair styles.

This time and effort to develop these relationships and looks may cause clients to refrain from trying new hairstyles, or trying new hairstylists. Furthermore, clients may refrain from recommending hairstylists they trust to prevent them from becoming too busy with other clients.

Since it can be tedious to remember all their clients' style preferences, it can be difficult for hairstylists to showcase their work, including new hairstyles, to prospective and current clients. Traditional marketing services, such as client word of mouth, and physical printed business cards, pamphlets, or brochures, do not adequately and quickly showcase a hairstylist's work.

Accordingly, the subject invention provides a beauty industry social media platform designed to provide on-demand geolocation beauty services that connect consumers to stylist through use of portable computing devices.

This invention will permit hairstylists to quickly and fully showcase their styling work to current and prospective clients via portable computing devices. Clients may seek out hairstylists by their styling work, or chose new hairstyles based on the showcased work. Clients can see beauty industry professionals near them and can choose one based off their uploaded portfolios. Hairstylists will also have the ability to network with other beauty industry professionals to find jobs, products, and trending hair styles.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a mobile screenshot of one embodiment of a Sign-in graphical user interface screen of the subject invention.

FIG. 2 is a mobile screenshot of one embodiment of an Account Setup graphical user interface screen of the subject invention.

FIG. 3 is a mobile screenshot of one embodiment of a second Account Setup graphical user interface screen of the subject invention.

FIG. 4 is a mobile screenshot of one embodiment of a User Location Account Setup graphical user interface screen of the subject invention.

FIG. 5 is a mobile screenshot of one embodiment of a Former Employers Account Setup graphical user interface screen of the subject invention.

FIG. 6 is a mobile screenshot of one embodiment of an Add a Photo Account Setup graphical user interface screen of the subject invention.

FIG. 7 is a mobile screenshot of one embodiment of a Stylist Member graphical user interface screen of the subject invention.

FIG. 8 is a mobile screenshot of one embodiment of a Stylist Navigation graphical user interface screen of the subject invention.

FIG. 9 is a mobile screenshot of one embodiment of a Stylist Profile graphical user interface screen of the subject invention.

FIG. 10 is a mobile screenshot of one embodiment of a Hair Salon Profile graphical user interface screen of the subject invention.

FIG. 11 is a mobile screenshot of one embodiment of a Client Profile graphical user interface screen of the subject invention.

FIG. 12 is a mobile screenshot of one embodiment of a Messaging user interface screen of the subject invention.

FIG. 13 is a mobile screenshot of one embodiment of an Inbox graphical user interface screen of the subject invention.

FIG. 14 is a mobile screenshot of one embodiment of a Hair Style Search graphical user interface screen of the subject invention.

FIG. 15 is a mobile screenshot of one embodiment of a Job Search graphical user interface screen of the subject invention.

FIG. 16 is a mobile screenshot of one embodiment of a Company Search graphical user interface screen of the subject invention.

FIG. 17 is a mobile screenshot of one embodiment of a Stylist Connections graphical user interface screen of the subject invention.

FIG. 18 is a mobile screenshot of one embodiment of a Hair Style Sharing graphical user interface screen of the subject invention.

FIG. 19 is a mobile screenshot of one embodiment of a Hair Style Photo Capture graphical user interface screen of the subject invention.

FIG. 20 is a mobile screenshot of one embodiment of a Hair Style Photo Filter graphical user interface screen of the subject invention.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses an on-line social media system for beauty service providers, comprising: a computing device comprising executable software; a data storage device; a first database of a plurality of beauty service provider identification information on the data storage device; a second database of a plurality of beauty service styles provided by each beauty service provider on the data storage device, wherein the second database is updated by each beauty service provider; a third database of open appointment times for each beauty service provider on the data storage device, wherein the third database is updated by each beauty service provider; a fourth database of a plurality of beauty service client identification information on the data storage device; a fifth database of beauty services requested by each beauty service client on the data storage device, wherein the fifth database is updated by each beauty service client; a sixth database of beauty service providers generated in substantial real time by the system by: i) matching the first database of beauty service providers with the fourth database for beauty service clients with a given geographic radius, ii) matching the second database of beauty service styles from the beauty service provider with the fifth database of beauty services requested by each beauty service client; wherein beauty service clients access the sixth database to select and make bids in substantial real time on the open appointment times for each beauty service provider from the third database; and further wherein beauty service providers access the sixth database to select and make bids in substantial real time to fulfill requested beauty services for beauty service clients.

The subject invention also discloses an on-line social media system for beauty service providers, comprising: a computing device comprising executable software; a data storage device; a first database of a plurality of beauty service provider identification information on the data storage device; a second database of a plurality of beauty service styles provided by each beauty service provider on the data storage device, wherein the second database is updated by each beauty service provider; a third database of open appointment times for each beauty service provider on the data storage device, wherein the third database is updated by each beauty service provider; a fourth database of a plurality of beauty service client identification information on the data storage device; a fifth database of beauty services requested by each beauty service client on the data storage device, wherein the fifth database is updated by each beauty service client; a sixth database of beauty service providers generated in substantial real time by the system by: i) matching the first database of beauty service providers with the fourth database for beauty service clients with a given geographic radius, ii) matching the second database of beauty service styles from the beauty service provider with the fifth database of beauty services requested by each beauty service client; wherein the system automatically notifies beauty service provider and beauty service clients in substantial real time of sixth database matches.

The subject invention further discloses an on-line social media system for beauty service providers, comprising: a computing device comprising executable software; a data storage device; a first database of a plurality of beauty service provider identification information on the data storage device; a second database of a plurality of images each displaying a beauty service style provided by each beauty service provider on the data storage device, wherein the second database is updated by each beauty service provider; a third database of open appointment times for each beauty service provider on the data storage device, wherein the third database is updated by each beauty service provider; a fourth database of a plurality of beauty service client identification information on the data storage device; a fifth database of beauty services requested by each beauty service client on the data storage device, wherein the fifth database is updated by each beauty service client; a sixth database of beauty service providers generated in substantial real time by the system by: i) matching the first database of beauty service providers with the fourth database for beauty service clients with a given geographic radius, ii) matching the second database of images of beauty service styles from each beauty service provider with the fifth database of beauty services requested by each beauty service client; wherein beauty service clients access the sixth database to select and make bids in substantial real time on the open appointment times for each beauty service provider from the third database; and further wherein beauty service providers access the sixth database to select and make bids in substantial real time to fulfill requested beauty services for beauty service clients.

The subject invention additionally discloses an on-line social media system for beauty service providers, comprising: a computing device comprising executable software; a data storage device; a first database of a plurality of beauty service provider identification information on the data storage device; a second database of a plurality of images each displaying a beauty service style provided by each beauty service provider on the data storage device, wherein the second database is updated by each beauty service provider; a third database of open appointment times for each beauty service provider on the data storage device, wherein the third database is updated by each beauty service provider; a fourth database of a plurality of beauty service client identification information on the data storage device; a fifth database of beauty service images that represent requested beauty services from beauty service client on the data storage device, wherein the fifth database is updated by each beauty service client; a sixth database of beauty service providers generated in substantial real time by the system by: i) matching the first database of beauty service providers with the fourth database for beauty service clients with a given geographic radius, ii) matching the second database of images of beauty service styles from each beauty service provider with the fifth database of beauty services images requested by each beauty service client; wherein beauty service clients access the sixth database to select and make bids in substantial real time on the open appointment times for each beauty service provider from the third database; and further wherein beauty service providers access the sixth database to select and make bids in substantial real time to fulfill requested beauty services for beauty service clients.

The subject invention further discloses an on-line social media system for beauty service providers to showcase available beauty services, comprising: a computing device comprising executable software; a data storage device; a first database of a plurality of beauty service provider identification information on the data storage device; a second database of a plurality of beauty service styles provided by each beauty service provider on the data storage device, wherein the second database is updated by each beauty service provider; a third database of open appointment times for each beauty service provider on the data storage device, wherein the third database is updated by each beauty service provider; a first graphical user interface screen that permits a user to search for any information from the first, second, and third databases on the computing device; a second graphical user interface screen that displays information from the first, second, and third databases for each beauty service provider to any user of the system on the computing device; a fourth database of a plurality of beauty service client identification information on the data storage device; a fifth database of beauty services requested by each beauty service client on the data storage device, wherein the fifth database is updated by each beauty service client; a third graphical user interface screen that permits a user to search for any information from the fourth and fifth databases on the computing device; a fourth graphical user interface screen that displays information from the fourth and fifth databases for each beauty service client to any user of the system on the computing device; a sixth database of beauty service providers generated in substantial real time by the system by: i) matching the first database of beauty service providers with the fourth database for beauty service clients with a given geographic radius, ii) matching the second database of beauty service styles from the beauty service provider with the fifth database of beauty services requested by each beauty service client; a fifth graphical user interface screen that displays information from the sixth database to any user of the system on the computing device; wherein beauty service clients access the fifth graphical user interface screen to select and make bids in substantial real time on the open appointment times for each beauty service provider; and further wherein beauty service providers access the fifth graphical user interface screen to select and make bids in substantial real time to fulfill requested beauty services for beauty service clients.

The subject invention also discloses a method of providing substantial real-time connections between beauty service providers and beauty service clients, comprising: a) providing interactive computing devices for use by the a plurality of beauty service providers and a plurality of beauty service clients, the interactive computing devices operable to receive and display a series of graphical user interface screens from a content management system; b) transmitting a first account registration screen to each beauty service provider, the first account registration screen promoting each beauty service provider to provide identification information to identify each beauty service provider; c) receiving a response from each beauty service provider from the first account registration screen; d) generating a first database of the plurality of beauty service provider identification information on the content management system; e) transmitting a beauty service styles screen to each beauty service provider, the beauty service styles screen promoting each beauty service provider to provide styles of beauty services offered; f) receiving a response from each beauty service provider from the beauty service styles screen; g) generating a second database of a plurality of beauty service styles provided by each beauty service provider on the content management system; h) transmitting an open appointment screen to each beauty service provider, the open appointment screen promoting each beauty service provider to provide upcoming open appointment times to provide beauty services; i) receiving a response from each beauty service provider from the open appointment screen; j) generating a third database of open appointment times for each beauty service provider on the content management system; k) transmitting a second account registration screen to each beauty service client, the second account registration screen promoting each beauty service client to provide identification information to identify each beauty service client; l) receiving a response from each beauty service client from the second account registration screen; m) generating a fourth database of the plurality of beauty service client identification information on the content management system; n) transmitting requested services screen to each beauty service client, the requested services screen promoting each beauty service client to provide requested beauty services; o) receiving a response from each beauty service client from the requested services screen; p) generating fifth database of beauty services requested by each beauty service client on the content management system; q) generating a sixth database of beauty service providers generated in substantial real time by the system by matching the first database of beauty service providers with the fourth database for beauty service clients with a given geographic radius and matching the second database of beauty service styles from the beauty service provider with the fifth database of beauty services requested by each beauty service client; r) allowing beauty service clients to select and make bids in substantial real time on the open appointment times for each beauty service provider from the third database; and s) allowing beauty service providers to select and make bids in substantial real time to fulfill requested beauty services for beauty service clients.

The subject invention also discloses a method of providing a social network for substantial real-time connections between beauty service providers and beauty service clients, comprising: a) providing interactive computing devices for use by the a plurality of beauty service providers and a plurality of beauty service clients, the interactive computing devices operable to receive and display a series of graphical user interface screens from a content management system; b) transmitting a first account registration screen to each beauty service provider, the first account registration screen promoting each beauty service provider to provide identification information to identify each beauty service provider; c) receiving a response from each beauty service provider from the first account registration screen; d) generating a first database of the plurality of beauty service provider identification information on the content management system; e) transmitting a beauty service styles screen to each beauty service provider, the beauty service styles screen promoting each beauty service provider to provide styles of beauty services offered; f) receiving a response from each beauty service provider from the beauty service styles screen; g) generating a second database of a plurality of beauty service styles provided by each beauty service provider on the content management system; h) transmitting an open appointment screen to each beauty service provider, the open appointment screen promoting each beauty service provider to provide upcoming open appointment times to provide beauty services; i) receiving a response from each beauty service provider from the open appointment screen; j) generating a third database of open appointment times for each beauty service provider on the content management system; k) transmitting a second account registration screen to each beauty service client, the second account registration screen promoting each beauty service client to provide identification information to identify each beauty service client; l) receiving a response from each beauty service client from the second account registration screen; m) generating a fourth database of the plurality of beauty service client identification information on the content management system; n) transmitting requested services screen to each beauty service client, the requested services screen promoting each beauty service client to provide requested beauty services; o) receiving a response from each beauty service client from the requested services screen; p) generating fifth database of beauty services requested by each beauty service client on the content management system; q) generating a sixth database of beauty service providers generated in substantial real time by the system by matching the first database of beauty service providers with the fourth database for beauty service clients with a given geographic radius and matching the second database of beauty service styles from the beauty service provider with the fifth database of beauty services requested by each beauty service client; r) generating a first graphical user interface screen that permits a user to search for any information from the first, second, and third databases on the computing device; s) generating a second graphical user interface screen that displays information from the first, second, and third databases for each beauty service provider to any user of the system on the computing device; t) generating a third graphical user interface screen that permits a user to search for any information from the fourth and fifth databases on the computing device; u) generating a fourth graphical user interface screen that displays information from the fourth and fifth databases for each beauty service client to any user of the system on the computing device; v) generating a fifth graphical user interface screen that displays information from the sixth database to any user of the system on the computing device; w) allowing beauty service clients to select and make bids in substantial real time on the open appointment times for each beauty service provider from the fifth graphical user interface screen; and x) allowing beauty service providers to select and make bids in substantial real time to fulfill requested beauty services for beauty service clients from the fifth graphical user interface screen.

The subject invention further discloses a method of providing substantial real-time connections between beauty service providers and beauty service clients, comprising: a) providing interactive computing devices for use by the a plurality of beauty service providers and a plurality of beauty service clients, the interactive computing devices operable to receive and display a series of graphical user interface screens from a content management system; b) transmitting a first account registration screen to each beauty service provider, the first account registration screen promoting each beauty service provider to provide identification information to identify each beauty service provider; c) receiving a response from each beauty service provider from the first account registration screen; d) generating a first database of the plurality of beauty service provider identification information on the content management system; e) transmitting a beauty service styles screen to each beauty service provider, the beauty service styles screen promoting each beauty service provider to provide styles of beauty services offered; f) receiving a response from each beauty service provider from the beauty service styles screen; g) generating a second database of a plurality of beauty service styles provided by each beauty service provider on the content management system; h) transmitting an open appointment screen to each beauty service provider, the open appointment screen promoting each beauty service provider to provide upcoming open appointment times to provide beauty services; i) receiving a response from each beauty service provider from the open appointment screen; j) generating a third database of open appointment times for each beauty service provider on the content management system; k) transmitting a second account registration screen to each beauty service client, the second account registration screen promoting each beauty service client to provide identification information to identify each beauty service client; l) receiving a response from each beauty service client from the second account registration screen; m) generating a fourth database of the plurality of beauty service client identification information on the content management system; n) transmitting requested services screen to each beauty service client, the requested services screen promoting each beauty service client to provide requested beauty services; o) receiving a response from each beauty service client from the requested services screen; p) generating fifth database of beauty services requested by each beauty service client on the content management system; q) generating a sixth database of beauty service providers generated in substantial real time by the system by matching the first database of beauty service providers with the fourth database for beauty service clients with a given geographic radius and matching the second database of beauty service styles from the beauty service provider with the fifth database of beauty services requested by each beauty service client; r) automatically notifying beauty service clients and beauty service providers of matches in the sixth database to allow them to select and make bids in substantial real time.

The subject invention also discloses a method of providing a social network for substantial real-time connections between beauty service providers and beauty service clients, comprising: a) providing interactive computing devices for use by the a plurality of beauty service providers and a plurality of beauty service clients, the interactive computing devices operable to receive and display a series of graphical user interface screens from a content management system; b) transmitting a first account registration screen to each beauty service provider, the first account registration screen promoting each beauty service provider to provide identification information to identify each beauty service provider; c) receiving a response from each beauty service provider from the first account registration screen; d) generating a first database of the plurality of beauty service provider identification information on the content management system; e) transmitting a beauty service styles screen to each beauty service provider, the beauty service styles screen promoting each beauty service provider to provide styles of beauty services offered; f) receiving a response from each beauty service provider from the beauty service styles screen; g) generating a second database of a plurality of beauty service styles provided by each beauty service provider on the content management system; h) transmitting an open appointment screen to each beauty service provider, the open appointment screen promoting each beauty service provider to provide upcoming open appointment times to provide beauty services; i) receiving a response from each beauty service provider from the open appointment screen; j) generating a third database of open appointment times for each beauty service provider on the content management system; k) transmitting a second account registration screen to each beauty service client, the second account registration screen promoting each beauty service client to provide identification information to identify each beauty service client; l) receiving a response from each beauty service client from the second account registration screen; m) generating a fourth database of the plurality of beauty service client identification information on the content management system; n) transmitting requested services screen to each beauty service client, the requested services screen promoting each beauty service client to provide requested beauty services; o) receiving a response from each beauty service client from the requested services screen; p) generating fifth database of beauty services requested by each beauty service client on the content management system; q) generating a sixth database of beauty service providers generated in substantial real time by the system by matching the first database of beauty service providers with the fourth database for beauty service clients with a given geographic radius and matching the second database of beauty service styles from the beauty service provider with the fifth database of beauty services requested by each beauty service client; r) generating a first graphical user interface screen that permits a user to search for any information from the first, second, and third databases on the computing device; s) generating a second graphical user interface screen that displays information from the first, second, and third databases for each beauty service provider to any user of the system on the computing device; t) generating a third graphical user interface screen that permits a user to search for any information from the fourth and fifth databases on the computing device; u) generating a fourth graphical user interface screen that displays information from the fourth and fifth databases for each beauty service client to any user of the system on the computing device; v) generating a fifth graphical user interface screen that displays information from the sixth database to any user of the system on the computing device; and w) automatically notifying beauty service clients and beauty service providers of matches in the sixth database to allow them to select and make bids in substantial real time on the fifth graphical user interface screen.

The subject invention further discloses a method of providing substantial real-time connections between beauty service providers and beauty service clients, comprising: a) providing interactive computing devices for use by the a plurality of beauty service providers and a plurality of beauty service clients, the interactive computing devices operable to receive and display a series of graphical user interface screens from a content management system; b) transmitting a first account registration screen to each beauty service provider, the first account registration screen promoting each beauty service provider to provide identification information to identify each beauty service provider; c) receiving a response from each beauty service provider from the first account registration screen; d) generating a first database of the plurality of beauty service provider identification information on the content management system; e) transmitting a beauty service styles screen to each beauty service provider, the beauty service styles screen promoting each beauty service provider to provide images of styles of beauty services offered; f) receiving a response from each beauty service provider from the beauty service styles screen; g) generating a second database of a plurality of beauty service style images provided by each beauty service provider on the content management system; h) transmitting an open appointment screen to each beauty service provider, the open appointment screen promoting each beauty service provider to provide upcoming open appointment times to provide beauty services; i) receiving a response from each beauty service provider from the open appointment screen; j) generating a third database of open appointment times for each beauty service provider on the content management system; k) transmitting a second account registration screen to each beauty service client, the second account registration screen promoting each beauty service client to provide identification information to identify each beauty service client; l) receiving a response from each beauty service client from the second account registration screen; m) generating a fourth database of the plurality of beauty service client identification information on the content management system; n) transmitting requested services screen to each beauty service client, the requested services screen promoting each beauty service client to provide requested beauty service style images; o) receiving a response from each beauty service client from the requested services screen; p) generating fifth database of beauty service style images requested by each beauty service client on the content management system; q) generating a sixth database of beauty service providers generated in substantial real time by the system by matching the first database of beauty service providers with the fourth database for beauty service clients with a given geographic radius and matching the second database of beauty service style images from the beauty service providers with the fifth database of beauty service styles images from the beauty service clients; r) allowing beauty service clients to select and make bids in substantial real time on the open appointment times for each beauty service provider from the third database; and s) allowing beauty service providers to select and make bids in substantial real time to fulfill requested beauty services for beauty service clients.

The subject invention further discloses a method of providing substantial real-time connections between beauty service providers and beauty service clients, comprising: a) providing interactive computing devices for use by the a plurality of beauty service providers and a plurality of beauty service clients, the interactive computing devices operable to receive and display a series of graphical user interface screens from a content management system; b) transmitting a first account registration screen to each beauty service provider, the first account registration screen promoting each beauty service provider to provide identification information to identify each beauty service provider; c) receiving a response from each beauty service provider from the first account registration screen; d) generating a first database of the plurality of beauty service provider identification information on the content management system; e) transmitting a beauty service styles screen to each beauty service provider, the beauty service styles screen promoting each beauty service provider to provide images of styles of beauty services offered; f) receiving a response from each beauty service provider from the beauty service styles screen; g) generating a second database of a plurality of beauty service style images provided by each beauty service provider on the content management system; h) transmitting an open appointment screen to each beauty service provider, the open appointment screen promoting each beauty service provider to provide upcoming open appointment times to provide beauty services; i) receiving a response from each beauty service provider from the open appointment screen; j) generating a third database of open appointment times for each beauty service provider on the content management system; k) transmitting a second account registration screen to each beauty service client, the second account registration screen promoting each beauty service client to provide identification information to identify each beauty service client; l) receiving a response from each beauty service client from the second account registration screen; m) generating a fourth database of the plurality of beauty service client identification information on the content management system; n) transmitting requested services screen to each beauty service client, the requested services screen promoting each beauty service client to provide requested beauty service style images; o) receiving a response from each beauty service client from the requested services screen; p) generating fifth database of beauty service style images requested by each beauty service client on the content management system; q) generating a sixth database of beauty service providers generated in substantial real time by the system by matching the first database of beauty service providers with the fourth database for beauty service clients with a given geographic radius and matching the second database of beauty service style images from the beauty service providers with the fifth database of beauty service styles images from the beauty service clients; r) generating a first graphical user interface screen that permits a user to search for any information from the first, second, and third databases on the computing device; s) generating a second graphical user interface screen that displays information from the first, second, and third databases for each beauty service provider to any user of the system on the computing device; t) generating a third graphical user interface screen that permits a user to search for any information from the fourth and fifth databases on the computing device; u) generating a fourth graphical user interface screen that displays information from the fourth and fifth databases for each beauty service client to any user of the system on the computing device; v) generating a fifth graphical user interface screen that displays information from the sixth database to any user of the system on the computing device; w) allowing beauty service clients to select and make bids in substantial real time on the open appointment times for each beauty service provider from the fifth graphical user interface screen; and x) allowing beauty service providers to select and make bids in substantial real time to fulfill requested beauty services for beauty service clients from the fifth graphical user interface screen.

In embodiments of the subject invention, the beauty service clients may automatically place pre-selected bids in substantial real time on the appointment openings of beauty service providers matched in the sixth database.

In further embodiments of the subject invention, the beauty service clients and beauty service providers may be automatically notified with the notification system selected from the group consisting of text messages, SMS, e-mails, and automated voice calls.

In other embodiments of the subject invention, the computing device may be selected from the group consisting of a laptop, a tablet, a smartphone, and a desktop computer.

In additional embodiments of the subject invention, the beauty service style may be selected from the group consisting of hair styles, hair colors, beard styles, nail colors, nail styles, make-up colors, and make-up styles.

In embodiments of the subject invention, the plurality of beauty service styles may comprise a plurality of images depicting each style.

In other embodiments of the subject invention, the beauty service provider may be selected from the group consisting of a cosmetologist, a hair stylist, a hair salon, a barber, a barbershop, a hair color specialist, a hair perm specialist, an esthetician, a manicurist, a nail salon, a makeup artist, a fashion stylist, a photo and movie Stylist, a hair weave extension specialist, a beautician, and a hair removal specialist.

In further embodiments of the subject invention, the invention may maintain on-line maps identifying beauty service provider locations that are part of the system.

In embodiments of the subject invention, the terms “substantial” or “substantially” are defined as at least close to (and can include) a given value or state, as understood by a person of ordinary skill in the art. In one embodiment, the terms “substantial” or “substantially” refers to ranges within 10%, preferably within 5%, more preferably within 1%, and most preferably within 0.1% of the given value or state being specified.

There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### DETAILED DESCRIPTION OF THE EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

The subject invention discloses an on-line social media platform system and method, incorporating a website and a corresponding mobile device application that will permit beauty industry service providers to electronically upload and maintain pages to showcase images of their work and styles. Prospective clients may electronically access and search the beauty service providers by geolocation and make appointments on-demand in real-time for services. Furthermore, hair salons and stylists can search clients seeking services, and make bids in real-time to offer their services.

In embodiments of the subject invention, the beauty service provider may be a Cosmetologist, Hairstylist, Hair Salon, Barber, Barbershop, Hair Color Specialist, Perm Specialist, Esthetician, Nail Care Artists, Manicurist, Nail Salon, Makeup Artist, Fashion Show Stylist, Photo and Movie Stylist, Hair weave or hair extension specialist, Beautician, or Hair removal specialist. The use of the term beauty service provider is not meant to be limiting.

In embodiments of the subject invention, the system may be accessed through on-line portals or downloadable software applications on personal computers, laptop computers, smartphones, tablet devices, or other computer workstations connected to the Internet through a wired or wireless connection. The network communication may be based on protocols such as Ethernet, IP, TCP, UDP, or IEEE 802.11.

The social media platform is run on multiple host servers; local, regional and national databases residing within the host servers; means for uploading data from a plurality of mobile computing devices; means for organizing all the uploaded data into the local, regional and national databases; means for running specific search queries from mobile computing devices on the databases; and means for displaying the search query results on the mobile computing devices. The host servers and the mobile computing devices include communication devices (such as a bus), a CPU/processor, a main operating memory, and a storage memory. Embodiments of the CPU/processor may include processors, microprocessors, multi-core processors, microcontrollers, system-on-chips, field programmable gate arrays (FPGA), application specific integrated circuits (ASIC), application specific instruction-set processors (ASIP), or graphics processing units (GPU). The host servers and the mobile computing devices store computer retrievable information and software executable instructions and may include solid state, magnetic, or optical recording mediums. Embodiments of an input terminal of the mobile computing devices may include a keyboard, a mouse, a pen, a microphone combined with voice recognition software, a camera, a multi-point touch screen, a bar code scanner, or a SKU scanner. In embodiments of the subject invention, the underlying architecture of the system may be implemented using one or more computer programs, each of which may execute under the control of an operating system, such as Windows, OS2, DOS, AIX, UNIX, MAC OS, iOS, ChromeOS, Android, and Windows Phone or CE.

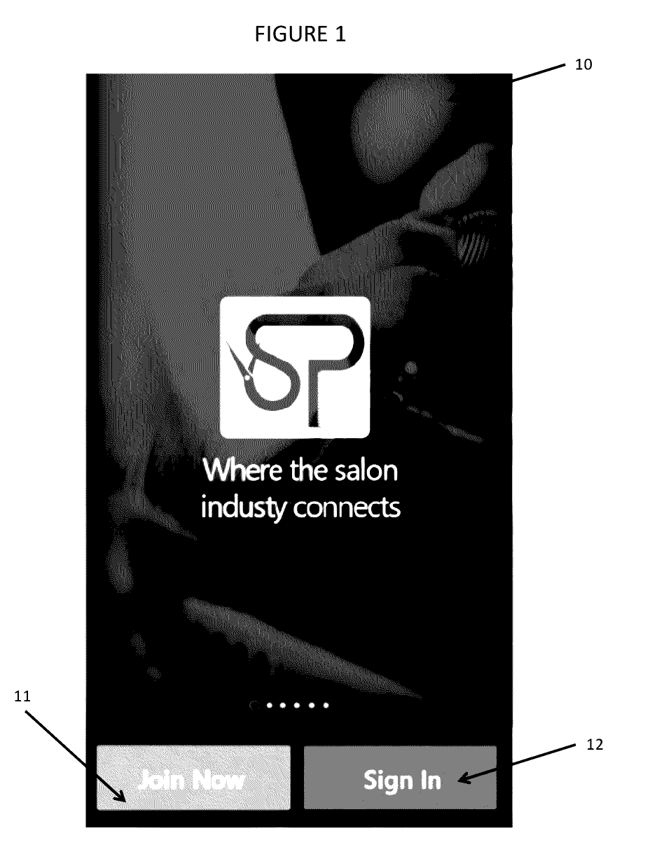

FIGS. 1-20 illustrate embodiments of the mobile screenshots of the graphical user interface screens of the subject invention.

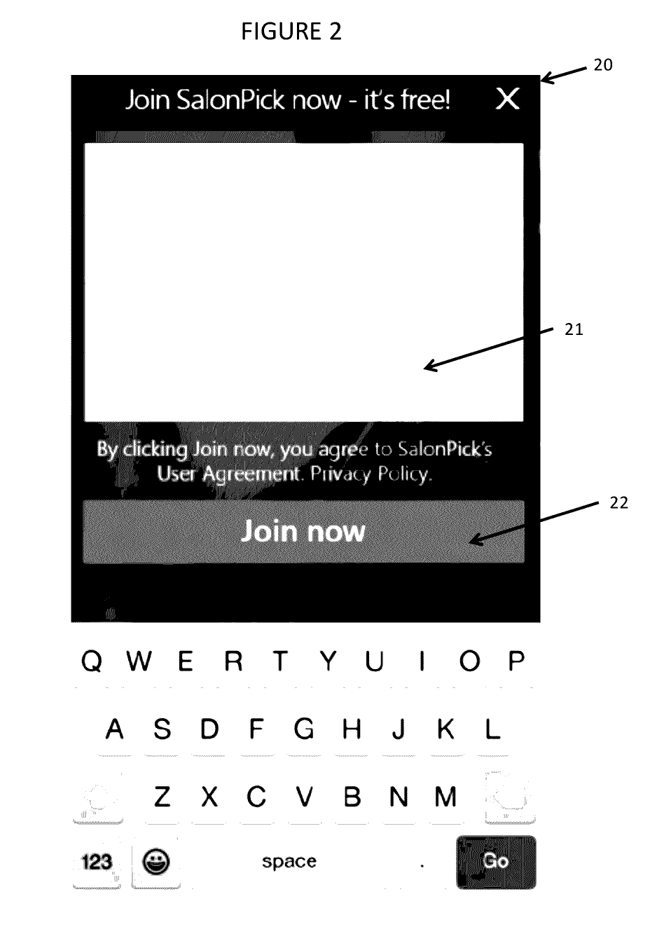

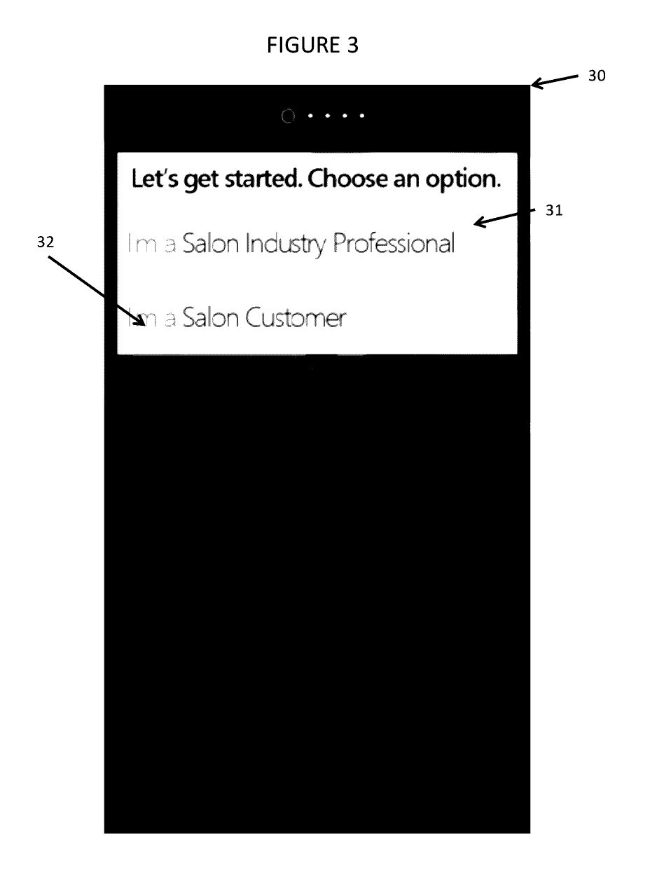

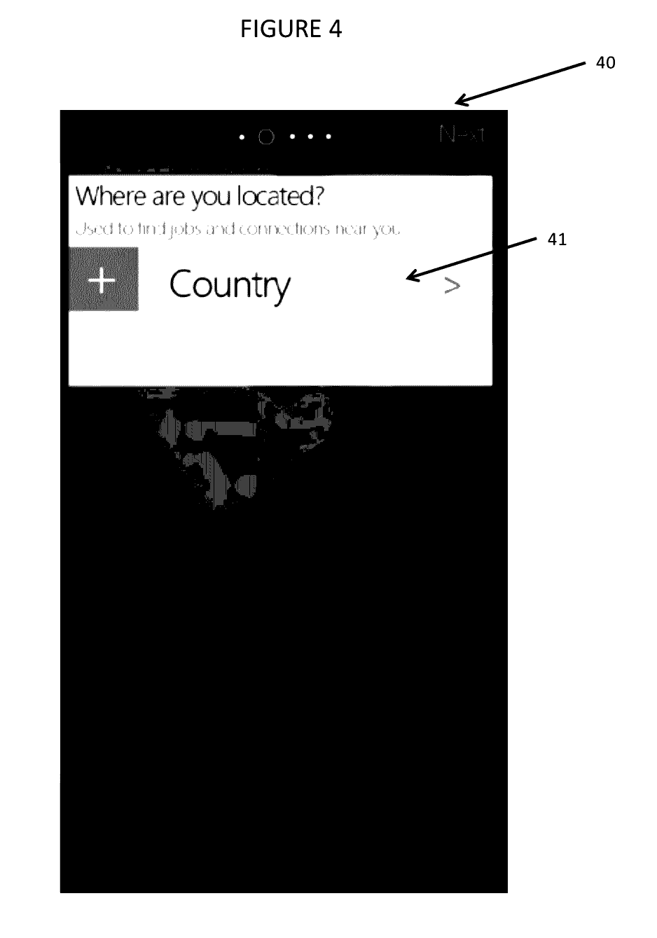

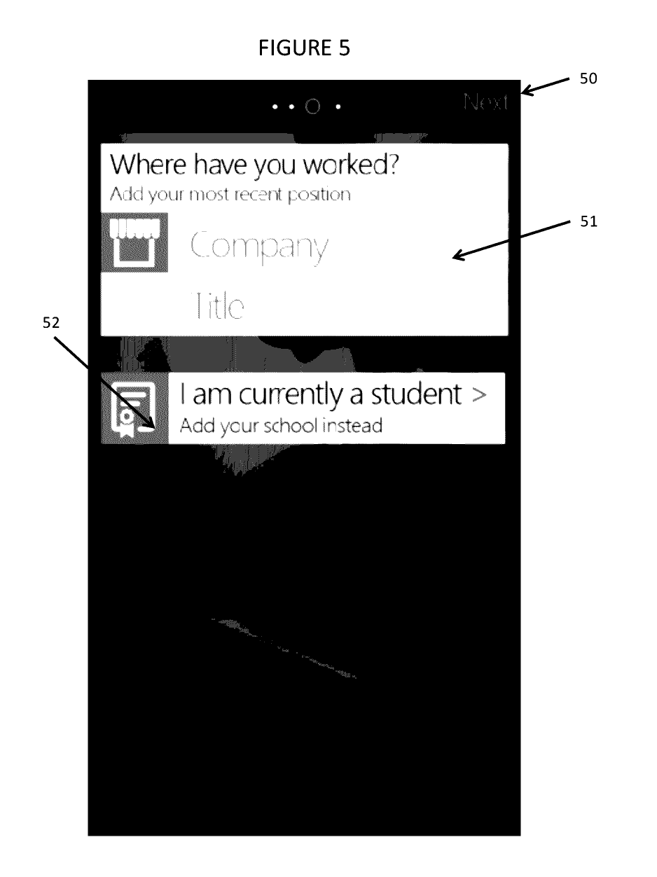

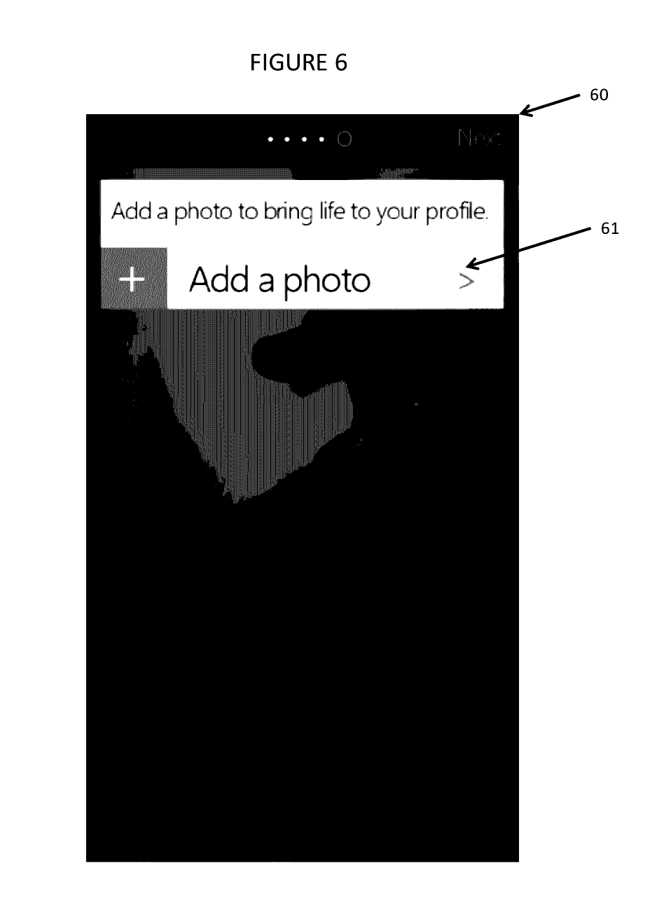

Once the software application for the system has been downloaded or accessed on-line, users will need to register an account for the system, including the creation of login information, providing contact information, providing business operation location(s), and indicating if the user is a customer or a beauty service provider. As illustrated in FIGS. 1-6, a client or a beauty service provider may set up a user account on the social media platform. FIG. 1 illustrates an opening screen 10 with a join button 11 for new accounts or a sign in button 12 to access existing accounts. FIG. 2 illustrates an account setup page 20 with data entry fields 21 that permit a user to enter and upload personal information, such as name, address, e-mail, passwords, telephone numbers to the system databases. Once this data fields 21 are complete, a user uploads the information to the system databases by actuating a join button 22. Once uploaded to the system databases, the system creates a user profile for the user. FIG. 3 illustrates an account setup page 30 that permit a user to select either a beauty industry professional button 31 or customer button 32 and upload this selection to the system databases. FIG. 4 illustrates an account setup page 40 with country or zip code data entry fields 41. FIG. 5 illustrates an account setup page 50 with employer data entry fields 51 or school data entry fields 52 that permit a user to enter and upload current and former employers or schools to the system databases. FIG. 6 illustrates an account setup page 60 with add a photo button 61 that permit a user to enter and upload personal and work photos to the system databases. In embodiments of the subject invention, the user may upload photos of themselves, and photos of their work, including, but not limited to: hair styles, hair colorings, nail styles, nail coloring, skin care results, hair removal, weave creation, hair extension insertions, or make-up results. In further embodiments of the subject invention, the system may accept biometric information, including, but not limited to: a retinal scan, a fingerprint, a thumbprint, a palm print, a voice sample, or a facial pattern to create and access an account.

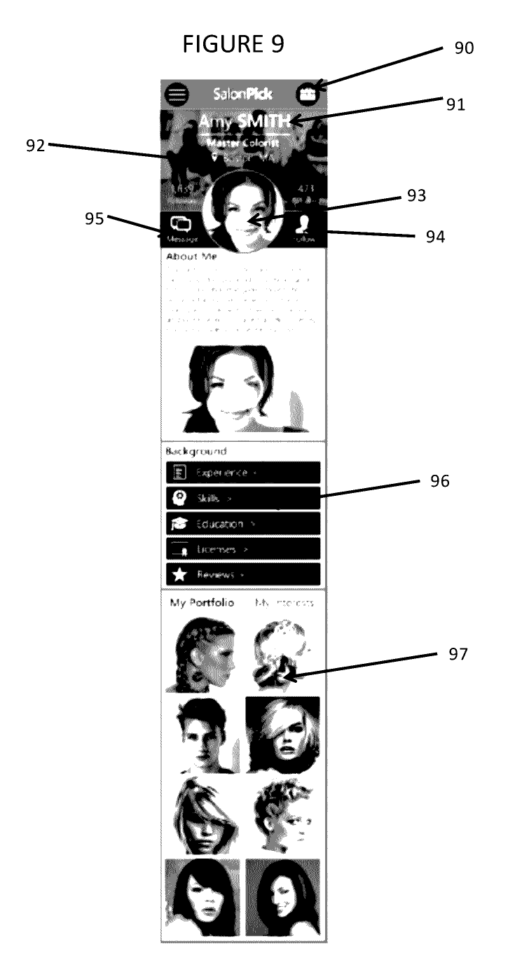

Once an account has been set up by the system, graphical user interface home pages will be created for each user based on the data entered on on screens 20, 30, 40, 50, and 60, as illustrated in FIGS. 9-11.

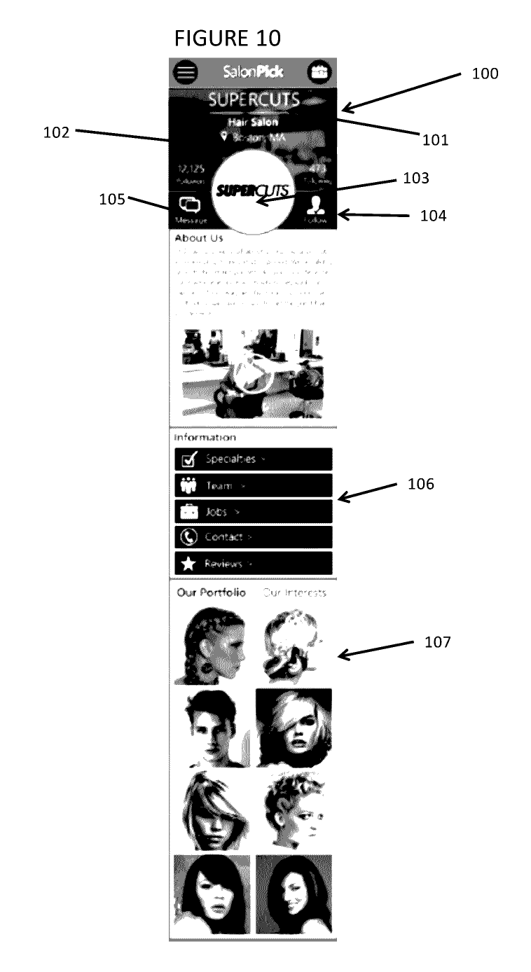

FIG. 9 illustrates a stylist member home page 90 with the stylist name 91, stylist geolocation 92, a profile photo 93, a follow button 94 for linking to a user's account, a message button 95 for messaging the stylist, and buttons 96 for displaying the stylist's experience, skills, education, licenses, reviews, and the stylist's uploaded photographic portfolio 97. FIG. 10 illustrates a salon home page 100 with the salon name 101, geolocation 102, a profile photo 103, a follow button 104 for linking to a user's account, a message button 105 for messaging the salon, buttons 106 for displaying specialties, team, jobs, contact, reviews, and the salon's uploaded photographic portfolio 107. In further embodiments of the subject invention, the software system may maintain template home pages for use or modification by beauty service providers.

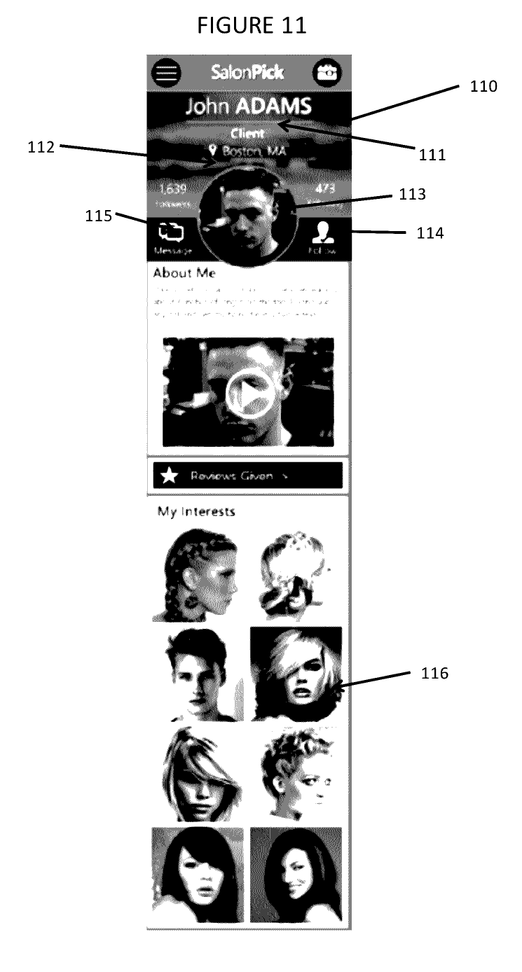

FIG. 11 illustrates a client member home page 110 with a name 111, geolocation 112, a profile photo 113, a follow button 114, a message button 115, and the client's photographic portfolio 116. In further embodiments of the subject invention, the software system may maintain template home pages for use or modification by client members.

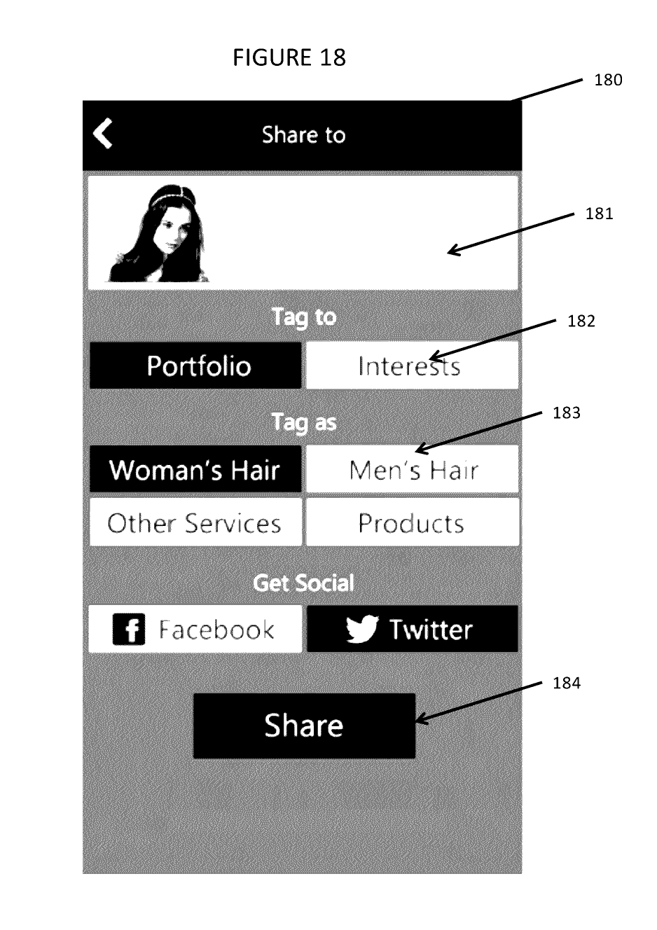

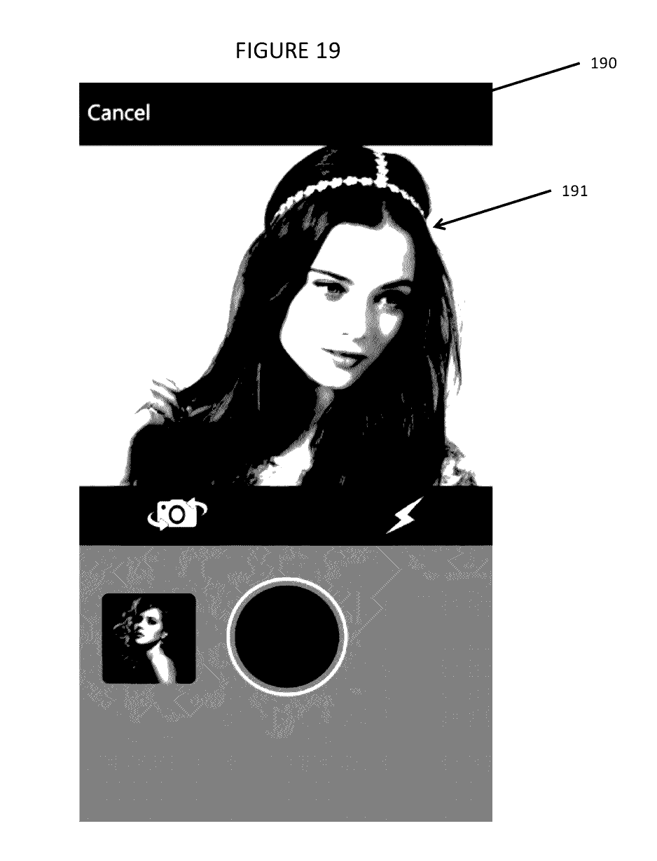

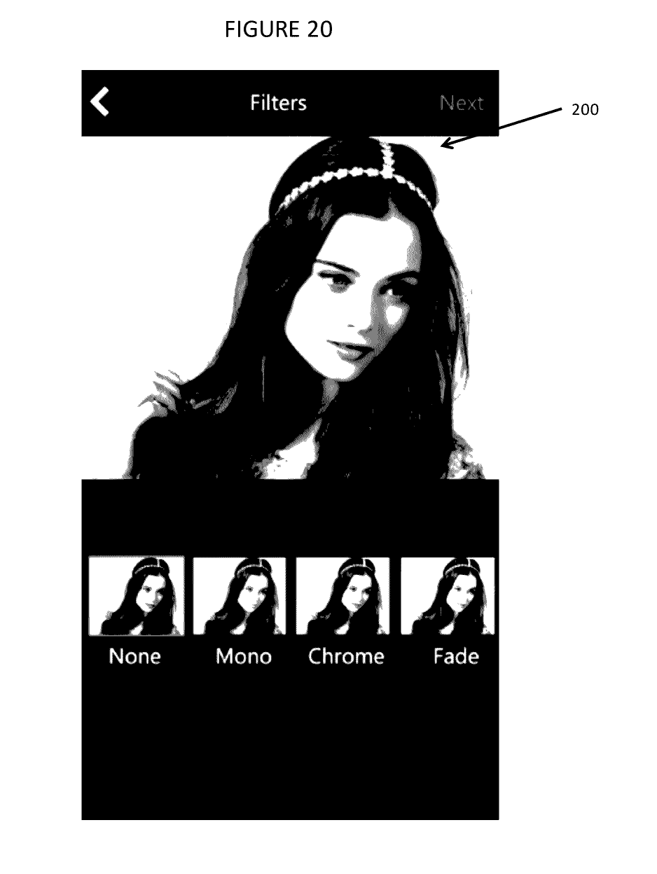

Beauty service providers and members will be provided with graphical user interface screens to add to, or adjust, their home pages 90, 100, and 110, such as photo capture screen 190, as illustrated in FIG. 19. Screen 190 permits users to take photos 191 of their own hair, own nails, hair they have styled, nails they have styled, make-up applications, magazine hair styles, magazine nail styles, or magazine make-up applications using a camera on the personal computing device. Users may edit these photos using filter screen 200, as illustrated in FIG. 20. Once edited, users may upload these photos to the system using a photo share screen 180, as illustrated in FIG. 18, which include data entry fields 181 for describing photos, tag to buttons 182 to categorize photos under portfolio of work done or interests, tag category buttons 183 to label photos, and share buttons 184 to upload photos to the system databases and home pages 90, 100, and 110. In further embodiments of the subject invention, the software system may maintain template images of hair styles, nail styles, or make-up styles for use or modification by users on their home pages.

Users will also be provided with graphical user interface screens that allow for easy searching of available beauty service providers or client members seeking services. Users may manually search with data entry fields for beauty service provider names; hair, nail, or make-up style images; hair, nail, or make-up style types; hair, nail, or make-up prices; beauty service provider locations, and zip codes. Users may also search the system databases by scanning and automatically uploading images of hair styles, nail styles, or make-up styles.

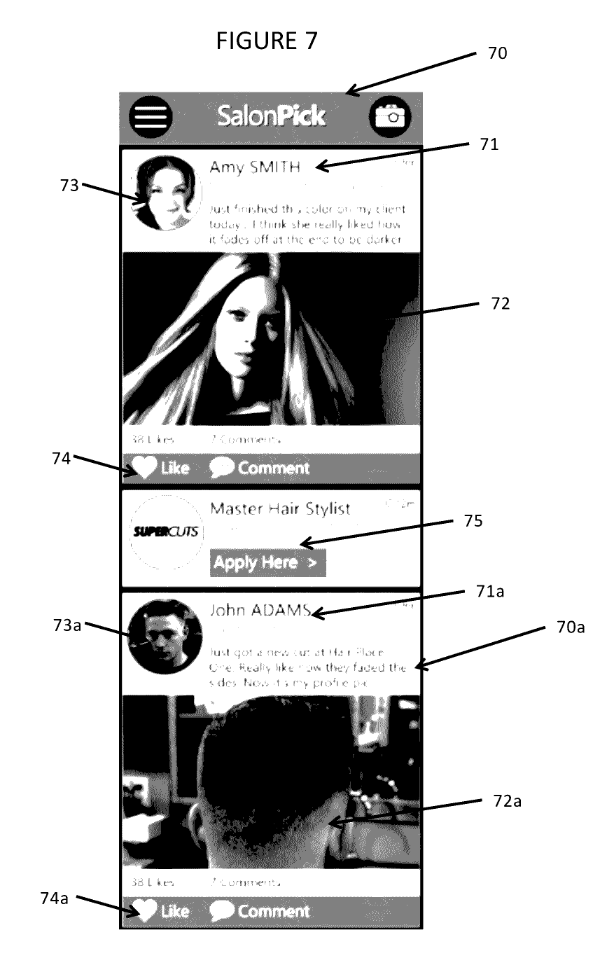

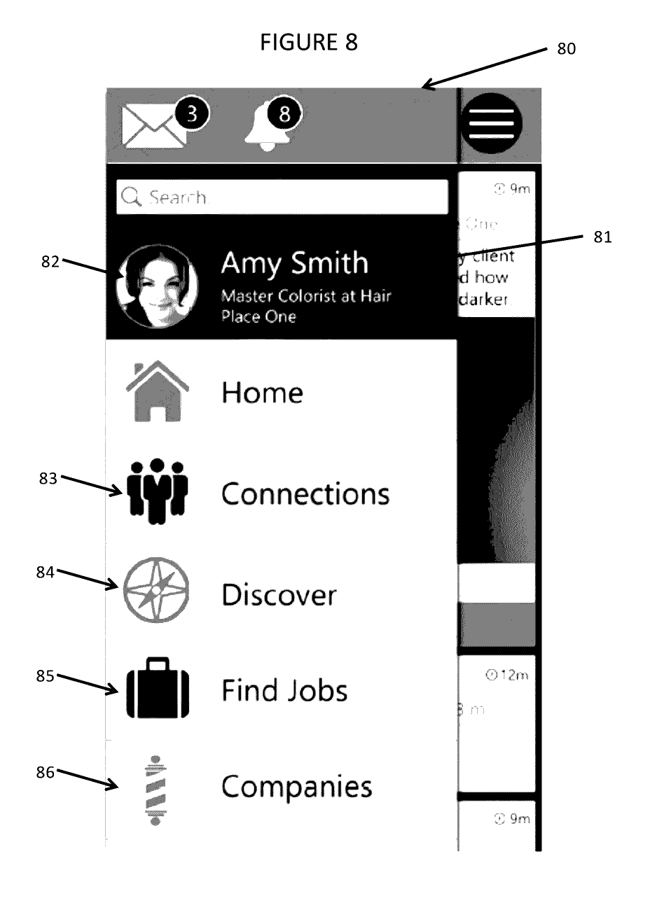

FIG. 7 illustrates a stylist member search result page 70 with a name 71, photo 72, a profile image 73, buttons 74 for comments or client input, and the stylist location 75. FIG. 7 also illustrates a client search result 70a with a name 71a, photo 72a, a profile image 73a, and buttons 74a for comments. FIG. 8 illustrates a stylist member navigation menu 80 with a name 81, a profile image 82, a button to search connections 83, a button to discover new hairstyles 84, a button to search for jobs 85, and a button to search companies 86.

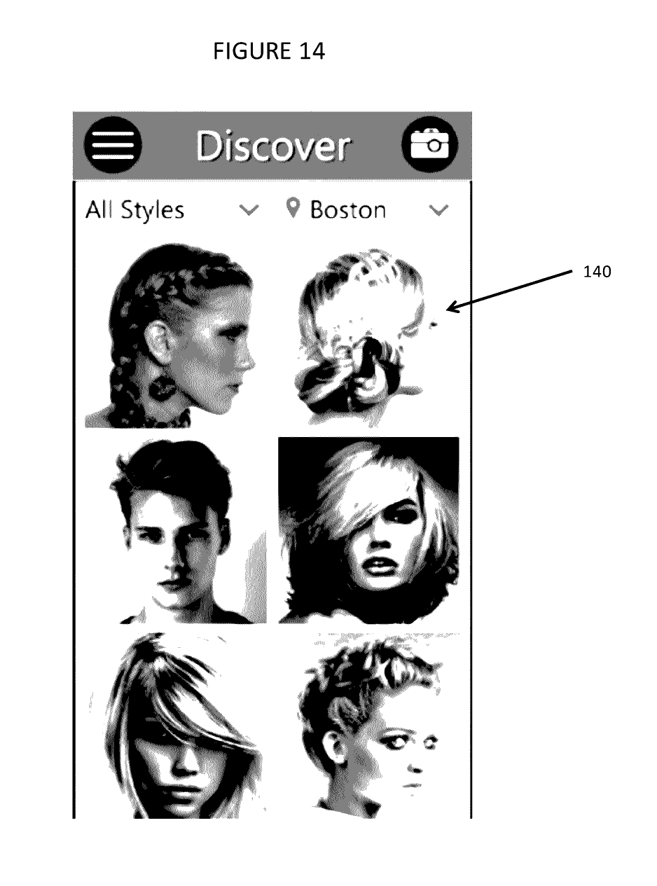

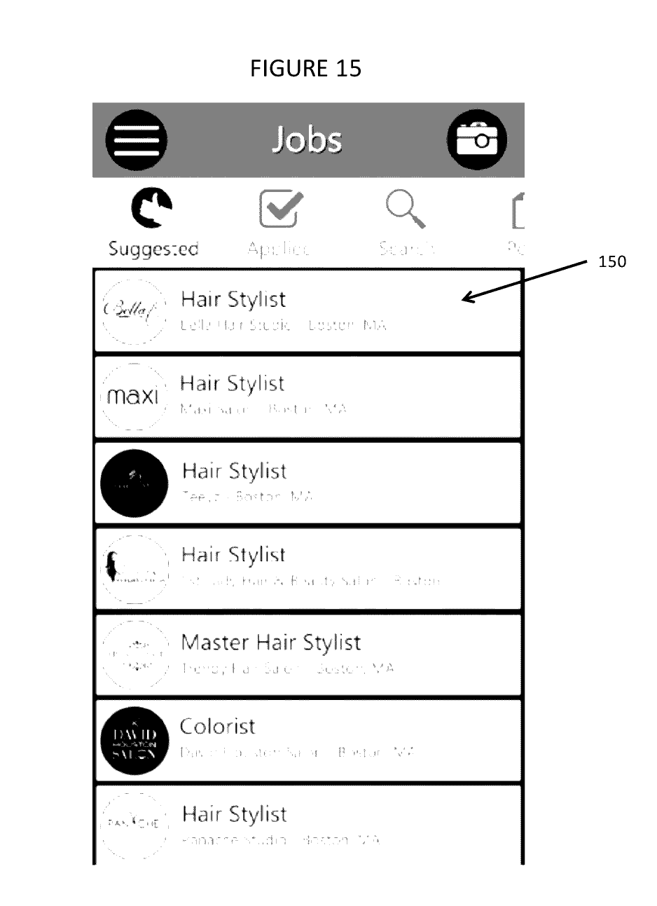

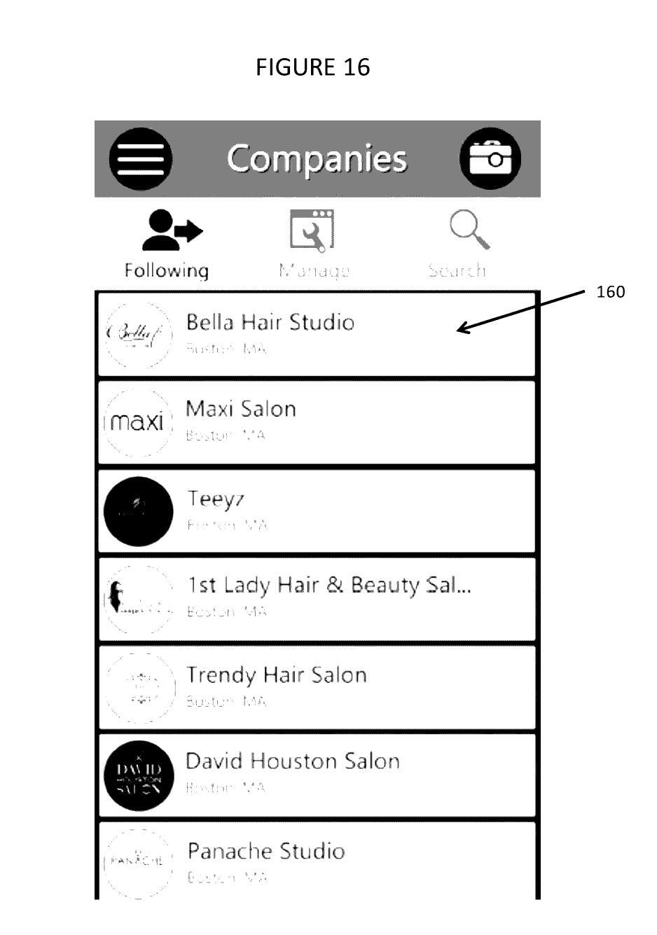

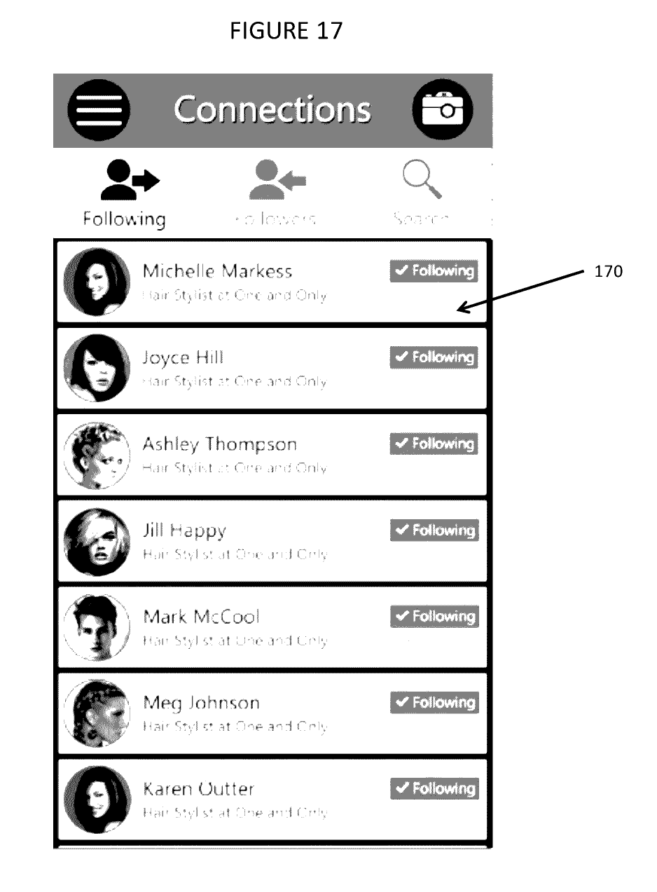

By clicking on any search results, a user may explore the home pages of a hairstylist 90, a client 110, or a hair salon 100. A user may select a hair stylist or salon by availability and geolocation. Stylists may select to only be available in a search when they are free to make an appointment. Other than searching for stylists or hair salons, users may click on the discover button 84 to search images of new hairstyles on hairstyle search screen 140, as illustrated in FIG. 14. Users may click on the jobs button 85 to search a job openings screen 150, as illustrated in FIG. 15. Users may click on the companies button 86 to search a beauty industry companies screen 160, as illustrated in FIG. 16. Users may click on the connections button 83 to search a connections screen 170, as illustrated in FIG. 17.

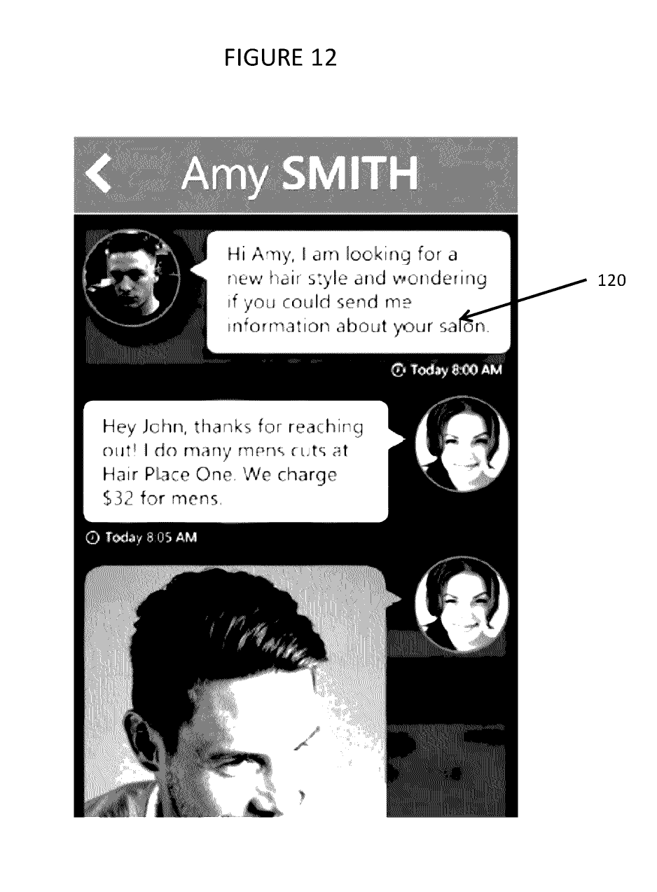

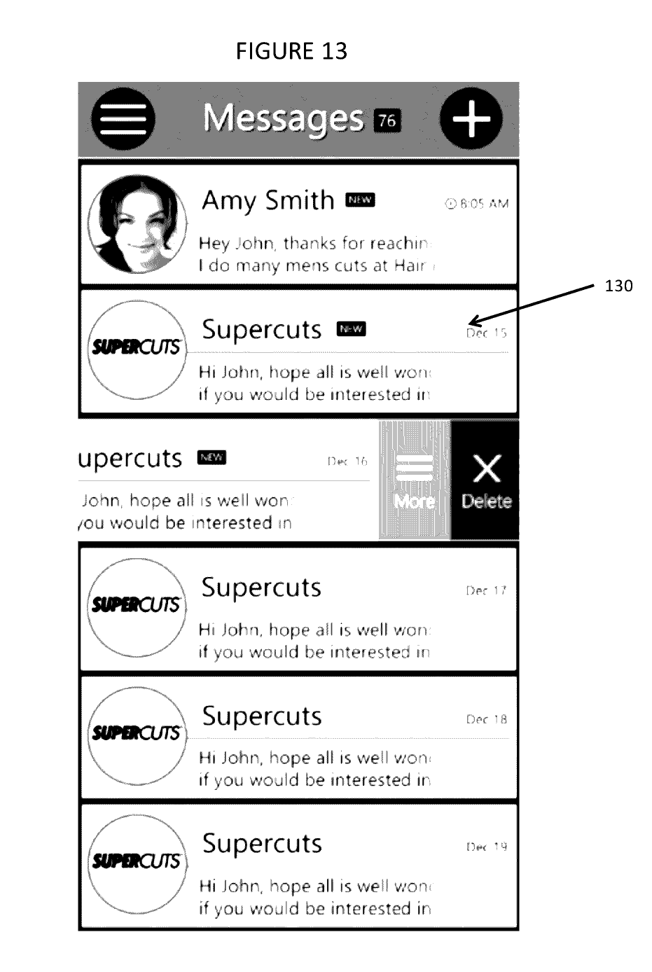

Once a user has selected a stylist, the user may message for an appointment on message screen 120, as illustrated in FIG. 12. The system keeps all of the messages for the user available on an inbox screen 130, as illustrated in FIG. 13. The social media platform notifies the hairstylist or salon of the client's name and contact information. Clients will have the ability to comment, rate, and refer hairstylists and salons upon completed services.

Users may establish automatic searches on a periodic basis for times when new services are wanted, upon vacancies or available times for certain beauty service providers. In additional embodiments of the subject invention, users may have automatic notifications forwarded to them electronically to their mobile computing devices by e-mail, SMS text, or other notification systems without conducting active searches.

Client members may set up a bidding process for beauty service providers to offer services, including same day, on-demand services. These bids may be set to automatic acceptance once a certain price point for a certain service, or by a given delivery time or date.

In embodiments of the subject invention, the social media platform may charge the service to the client and keep a percentage, or flat fee, or each service appointment completed through the platform. Hairstylists and hair salons may maintain billing accounts on the social media platform. In additional embodiments of the subject invention, the social media platform may generate revenue through subscription access fees, on-line advertising, or a percentage of sales generated through the system, or a transaction fee.

A further embodiment of the system will include rating systems for beauty service provider. Any client may rate the quality of services, professionalism, and costs. Ratings may be ranked on the system.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. An on-line social media system for beauty service providers, comprising:
a computing device comprising executable software; a data storage device;
a first database of a plurality of beauty service provider identification information on the data storage device;
a second database of a plurality of beauty service styles provided by each beauty service provider on the data storage device, wherein the second database is updated by each beauty service provider;
a third database of open appointment times for each beauty service provider on the data storage device, wherein the third database is updated by each beauty service provider;
a fourth database of a plurality of beauty service client identification information on the data storage device;
a fifth database of beauty services requested by each beauty service client on the data storage device, wherein the fifth database is updated by each beauty service client;
a sixth database of beauty service providers generated in substantial real time by the system by: i) matching the first database of beauty service providers with the fourth database for beauty service clients with a given geographic radius, ii) matching the second database of beauty service styles from the beauty service provider with the fifth database of beauty services requested by each beauty service client;
wherein beauty service clients access the sixth database to select and make bids in substantial real time on the open appointment times for each beauty service provider from the third database; and further wherein beauty service providers access the sixth database to select and make bids in substantial real time to fulfill requested beauty services for beauty service clients.

2. The system of claim 1, wherein beauty service clients automatically place pre-selected bids in substantial real time on the appointment openings of beauty service providers matched in the sixth database.

3. The system of claim 1, wherein the client and beauty service providers are automatically notified with a notification system selected from the group consisting of text messages, SMS, e-mails, and automated voice calls.

4. The system of claim 1, wherein the computing device is selected from the group consisting of a laptop, a tablet, a smartphone, and a desktop computer.

5. The system of claim 1, wherein the beauty service style is selected from the group consisting of hair styles, hair colors, beard styles, nail colors, nail styles, make-up colors, and make-up styles.

6. The system of claim 1, wherein the plurality of beauty service styles comprises a plurality of images, each depicting one style.

7. The system of claim 1, wherein the beauty service provider is selected from the group consisting of a cosmetologist, a hair stylist, a hair salon, a barber, a barbershop, a hair color specialist, a hair perm specialist, an esthetician, a manicurist, a nail salon, a makeup artist, a fashion stylist, a photo and movie Stylist, a hair weave extension specialist, a beautician, and a hair removal specialist.

8. An on-line social media system for beauty service providers, comprising:
a computing device comprising executable software; a data storage device; a first database of a plurality of beauty service provider identification information on the data storage device;
a second database of a plurality of beauty service styles provided by each beauty service provider on the data storage device, wherein the second database is updated by each beauty service provider;
a third database of open appointment times for each beauty service provider on the data storage device, wherein the third database is updated by each beauty service provider;
a fourth database of a plurality of beauty service client identification information on the data storage device;
a fifth database of beauty services requested by each beauty service client on the data storage device, wherein the fifth database is updated by each beauty service client;
a sixth database of beauty service providers generated in substantial real time by the system by: i) matching the first database of beauty service providers with the fourth database for beauty service clients with a given geographic radius, ii) matching the second database of beauty service styles from the beauty service provider with the fifth database of beauty services requested by each beauty service client;
wherein the system automatically notifies beauty service provider and beauty service clients in substantial real time of sixth database matches.

9. The system of claim 8, wherein beauty service clients automatically place pre-selected bids in substantial real time on the appointment openings of beauty service providers matched in the sixth database.

10. The system of claim 8, wherein the client and beauty service providers are automatically notified with a notification system selected from the group consisting of text messages, SMS, e-mails, and automated voice calls.

11. The system of claim 8, wherein the computing device is selected from the group consisting of a laptop, a tablet, a smartphone, and a desktop computer.

12. The system of claim 8, wherein the beauty service style is selected from the group consisting of hair styles, hair colors, beard styles, nail colors, nail styles, make-up colors, and make-up styles.

13. The system of claim 8, wherein the plurality of beauty service styles comprises a plurality of images depicting each style.

14. The system of claim 8, wherein the beauty service provider is selected from the group consisting of a cosmetologist, a hair stylist, a hair salon, a barber, a barbershop, a hair color specialist, a hair perm specialist, an esthetician, a manicurist, a nail salon, a makeup artist, a fashion stylist, a photo and movie Stylist, a hair weave extension specialist, a beautician, and a hair removal specialist.

15. An on-line social media system for beauty service providers, comprising:
a computing device comprising executable software; a data storage device; a first database of a plurality of beauty service provider identification information on the data storage device;
a second database of a plurality of images each displaying a beauty service style provided by each beauty service provider on the data storage device, wherein the second database is updated by each beauty service provider;
a third database of open appointment times for each beauty service provider on the data storage device, wherein the third database is updated by each beauty service provider;
a fourth database of a plurality of beauty service client identification information on the data storage device;
a fifth database of beauty service images that represent requested beauty services from beauty service client on the data storage device, wherein the fifth database is updated by each beauty service client;
a sixth database of beauty service providers generated in substantial real time by the system by: i) matching the first database of beauty service providers with the fourth database for beauty service clients with a given geographic radius, ii) matching the second database of images of beauty service styles from each beauty service provider with the fifth database of beauty services images requested by each beauty service client;
wherein beauty service clients access the sixth database to select and make bids in substantial real time on the open appointment times for each beauty service provider from the third database; and further wherein beauty service providers access the sixth database to select and make bids in substantial real time to fulfill requested beauty services for beauty service clients.

16. The system of claim 15, wherein beauty service clients automatically place pre-selected bids in substantial real time on the appointment openings of beauty service providers matched in the sixth database.

17. The system of claim 15, wherein the client and beauty service providers are automatically notified with a notification system selected from the group consisting of text messages, SMS, e-mails, and automated voice calls.

18. The system of claim 15, wherein the computing device is selected from the group consisting of a laptop, a tablet, a smartphone, and a desktop computer.

19. The system of claim 15, wherein the beauty service style is selected from the group consisting of hair styles, hair colors, beard styles, nail colors, nail styles, make-up colors, and make-up styles.

20. The system of claim 15, wherein the beauty service provider is selected from the group consisting of a cosmetologist, a hair stylist, a hair salon, a barber, a barbershop, a hair color specialist, a hair perm specialist, an esthetician, a manicurist, a nail salon, a makeup artist, a fashion stylist, a photo and movie Stylist, a hair weave extension specialist, a beautician, and a hair removal specialist.
